(19) United States
(12) Patent Application Publication
(10) Pub. No.: US 2009/0123748 A1
(43) Pub. Date: May 14, 2009

(54) Process for the production of high tensile strength and low creep polymer yarns, high tensile strength and low creep polymer or copolymer yarns, and, the use of such yarns

(75) Inventors: Leticia Socal da Silva, Porto Alegre - RS (BR); Alan Kardec do Nascimento, Salvador (BR); Breno de La Rue, Americana - SP (BR); Marcos Roberto Paulino Bueno, Porto Alegre - RS (BR); Martha de La Rue Beckedorf, Americana (BR)

Correspondence Address: BIRCH STEWART KOLASCH & BIRCH, PO BOX 747, FALLS CHURCH, VA, 22040-0747, US

(73) Assignees: BRASKEM S.A., Camacari - BA (BR); PROFIL IND E COM DE FIOS LTDA., Nova Odessa (BR)

(21) Appl. No.: 12/081,787

(22) Filed: Apr. 21, 2008

(30) Foreign Application Priority Data
Nov. 8, 2007 (BR) PI0705699-0

(51) Int. Cl. C08K 3/34; D02G 3/02

(52) U.S. Cl. 428/364; 523/122; 524/445; 524/447; 264/28; 264/211.12

(57) ABSTRACT

The present invention relates to a process for the production of high tensile strength and low creep polymer yarns, wherein it comprises the following steps: (a) preparing a mixture of: (i) a first ultra high molecular weight polyolefin polymer or copolymer, (ii) a second clay nanocomposite polyolefin polymer or copolymer, and (iii) a non-polar spinning solvent, (b) feeding the resulting suspension through an extruder at a temperature of at least 180° C., causing the formation of a gel, (c) spinning the gel so obtained in a spinneret with a length to diameter ratio (L/D) of at least 15, (d) cooling the yarn to a temperature below 2° C., (e) subsequently removing the non-polar spinning solvent, and (f) drawing the yarn so obtained so as to obtain a tensile strength value of at least 18 cN/Dtex and a creep value lower than 0.07% per hour, wherein the first ultra high molecular weight polyolefin polymer or copolymer has a weight-average molecular weight higher than 2,000,000 g/mol and a polydispersivity of at least 7, and the second clay nanocomposite polyolefin polymer or copolymer is obtained via in situ polymerization of an olefin and an exfoliated layered clay, the polyolefin so obtained having a weight-average molecular weight of at least 400,000 g/mol.

### FIELD OF THE INVENTION

The present invention relates to a process for producing high tensile strength and low creep polymer yarns from ultra high molecular weight polymers or copolymers which contain in their compositions a nanometric exfoliated layered clay. More specifically, the present invention relates to the obtention of yarns from an ethylene polymer or copolymer with a multimodal molecular weight distribution, comprising different contents of a nanometric exfoliated layered clay. The invention yet relates to the use of these high tensile strength and low creep yarns in such applications that require high resistance under constant stress, such as ropes and mooring lines and hose reinforcements, besides conventional applications such as ballistic materials and fishing lines.

### BACKGROUND OF THE INVENTION

Yarns based on ultra high molecular weight polyolefins, such as ultra high molecular weight polyethylene (UHMW PE), are known and widely disclosed in the literature for their high tensile strength and high elastic modulus. These yarns are obtained by gel spinning processes, in which the polymer is spun in the presence of a spinning solvent and subsequently drawn up to the point at which the desired properties are achieved. Due to their excellent properties, which pair high resistance and low weight, these yarns are used in special applications such as ballistic fabrics and composites, deep sea nets and fishing lines, mooring lines and cables.

Depending on the desired use, it may be possible that very particular properties be required, even better properties than those exhibited by the yarns already known to the art. For instance, in the case of mooring lines and cables, it is necessary that the yarn to be used to manufacture the specific lines has low creep when under constant stress and at the same time a high tensile strength. This low creep is instrumental in the choice of yarn to be used in the manufacture of the rope or cable. Creep is defined as the dimensional change of a body as a function of time, when it is subjected to a constant static stress. In order to determine creep, a constant stress is applied to a test sample of a specific shape, in a determined essay routine (tensile strength, compressive stress, flexural strength or torsion), at a specific temperature. The deformation of the test sample is recorded as a function of test time. A practical example of this property would be a 1,000 meter long cable made from a material having a 3% per day creep being used in securing an oil rig, wherein after being subjected to a constant load for two days, the rig would move 60 meters away from its initial location.

Polyester yarns are currently widely used in ropes due to its low creep. However, the downside of it is the low tensile strength of that yarn, which leads to the manufacture of ropes and cables of large dimensions and high weight, making them difficult to be handled when laying and tailing, therefore limiting their manageable total length. Another key property of these lines that are used in naval applications is that they float in water, for that will represent a very definite safety issue in the case they break or get loose. A polyester yarn has an apparent density in excess of 1 g/cm³, whereas an UHMW PE yarn has a density of 0.97 g/cm³, which allows it to float in water. The manufacture of ropes and cables using yarns obtained from UHMW PE overcomes those hurdles presented above, however exhibiting a creep problem, which is worse than that of polyester. At a molecular level, creep property is related to the sliding and/or the entanglement of the polymer molecules.

Many studies have been developed aiming to reduce polyethylene yarn creep. U.S. Pat. No. 5,066,755, assigned to Stamicarbon, claims the fabrication of low creep yarns by means of gamma radiation induced partial reticulation. According to this patent, the yarn is irradiated after partial solvent removal and before drawing, the resulting yarn having reduced elongation and creep, but paired with a loss of yarn tensile strength. The high energy radioactive cobalt sources, which are necessary to promote the ionization and cross-linking of the chains, require highly hazardous operational equipment and infra-structure, as well as special care during its utilization, which pose a process disadvantage.

U.S. Pat. No. 5,578,374, assigned to Allied, describes low creep, high elastic modulus and high tensile strength yarns produced by means of an extra drawing process stage, called post-drawing, in which the filament is drawn more slowly and under higher temperatures. The yarn so obtained has 25% lower creep than the regularly drawn yarn, besides having higher resistance at high temperatures. The disadvantage of this process resides in the need of an extra drawing stage and at a very low velocity, which can render the on line production of the yarn very slow.

Mitsui's patent application EP 0320188 A2 discloses low creep filaments manufactured from ultra high molecular weight polyethylenes comprising different co-monomer contents. However, the raw material polymers used for the obtention of such yarns are hard to be produced in an industrial scale, due to the high degree of chain branching required, thus making it a less economically competitive process.

The practice of adding fillers to polymers aiming to enhance their physical properties is well known in the art. As a rule, fillers are insoluble solid materials, which are added to polymers, during its processing stages, in high enough quantities to change, in a controlled way, some or all of their physical properties. The combination of polymer and filler yields an heterogeneous material comprising two or more distinct solid phases, the so-called composite. The size and the particle size distribution of the filling material used affect its mechanical and rheological properties, since they define the contact surface area among the various system components. Whenever, for example, the filler is poorly spread throughout the system, and/or it is in the form of small agglomerates, this renders the composite brittle, making it prone to failure. The onset of nanotechnology brought many advantages to this area of expertise. Nanofillers are materials with a particle size of the order of nanometers, that is, 10⁻⁹ m, where at least one of the dimensions must be smaller than 100 nm. The shape of the nanosized particles can be spherical (titanium dioxide, silica, alumina, etc.), tubular (carbon nanotubes) or layered (clay, graphite). Nanofillers have the ability of reinforcing polymer matrices in a better way than traditional reinforcement agents, even at low inorganic material concentrations. These nanosized particles are incorporated into the polymer matrices providing a large improvement in their properties. In order to achieve set performance requirements or specific properties, when using traditional fillers with a particle size of the order of micron, one must add volumes of the order of 30% final product weight, while when using nanosized materials one can resort to just 5% to 10%, in weight, rendering it a lighter end product.

The simple blending of a polymer and a nanofiller may not lead to the formation of a high performance material, because it is necessary that the nanofiller be completely dispersed with the polymer chains in order to have an end product with superior properties.

There are few studies about the utilization of nanofillers in the manufacture of polymer yarns. The modification of ultra high molecular weight polyethylene (UHMW PE) with carbon nanotubes (CNT) is disclosed in the patent application WO 03/069032A1, assigned to DSM, wherein a nanotube colloidal dispersion in a polymer solution is extruded and drawn with the aid of a surfactant. The yarn disclosed in this patent application has mechanical properties superior to those of the yarn with no filler whatsoever, but creep values are not disclosed. Besides, it is known that the current cost of CNT makes unfeasible its industrial use in the manufacture of such a polymer product.

Patent application WO 2006/010521, assigned to DSM, discloses a process for manufacturing CNT containing yarns, said nanotubes undergoing a preliminary acid treatment, thereby making the final nanotube contents lower than the contents disclosed in the abovementioned patent application (WO 03/069032A1). The process disclosed does not resort to surfactants, but it becomes more complex due to the required CNT acid pre-treatment. The yarns thus claimed have high tensile strength and elastic modulus values, but no creep data are shown and the high CNT cost renders the process unfeasible for producing industrial polymer product.

In the aim to obtain polymers with better mechanical, thermal and barrier properties, Braskem developed a process for the synthesis of ultra high molecular weight polyolefin nanocomposites, which comprise different contents of an exfoliated organophylic phyllosilicate obtained via in situ polymerization. In this nanocomposite, the phyllosilicate is completely exfoliated and distributed within the polymer, in such a way that the clay layers have dimensions smaller than 100 nm.

The inventors of the present patent application ascertained that, when starting from ultra high molecular weight polyolefins comprising exfoliated layered nanosized clays in its matrix, obtained via in situ polymerization, such as disclosed in the Brazilian patent application PI 0605664-4, assigned to Braskem, it would be possible to obtain, through a gel spinning process, yarns with surprisingly improved properties, to the point that these yarns could be advantageously used in the production of mooring ropes and cables. It is believed that the obtention of these surprising properties is due to the fact that the yarn so obtained, after the extrusion, spinning and drawing steps, presents a micro-morphological structure in which the rigid clay layers reduce the inter-slippage of the polyethylene chains, thus reducing their creep under constant stress. The extrusion, spinning and drawing conditions used, as well as the polymer mixture composition and the type of the clay filler, were adjusted in such a way to produce a yarn simultaneously having high tensile strength and low creep.

The present invention relates to the production of high tensile strength and low creep yarns, modified by means of adding exfoliated layered clays. Thus, in the process of the present invention, it is used a polyolefin nanocomposite, which may comprise different contents of a nanosized clay, so as to obtain yarns for applications which require high resistance and low deformation under constant stress, such as the case of mooring cables and lines, on top of conventional ballistic materials and fishing line uses. The yarn spinning process, known as gel spinning, is used for the production of said yarns. In the process herein disclosed, ultra high molecular weight polyethylene is, firstly, mixed with a nanocomposite comprising a polymer phase and an inorganic clay containing phase, and then both are extruded with the aid of a spinning solvent. After the extrusion, the multi-filament bundle is cooled, the solvent is eliminated and the yarn is drawn to, at least, 18 cN/denier tensile strength, and, at most, 0.07% per hour creep. In this same product there are paired high tensile strength and low creep, which are the ideal characteristics for the use of such a product in mooring ropes and cables, besides reinforcements for hoses.

### SUMMARY OF THE INVENTION

One of the purposes of the present invention is to provide a process for obtaining high tensile strength and low creep yarns, which contain nanosized layered clay fillers. The products thus manufactured by means of the process herein disclosed pair high tensile strength and low creep, for use in applications which require high resistance under a constant stress, such as mooring cables and lines, besides hose reinforcements. The yarns may also be used for ballistic materials, as well as fishing lines. A gel spinning process may be chosen for the manufacture of such ultra high molecular weight yarns. In the process of the present invention, an ultra high molecular weight polyethylene, with average molar weight of at least 2,000,000 g/mol, is mixed with a polyethylene nanocomposite comprising 40% of nanosized layered clay particles. The polymer phase of the nanocomposite has molar weights from 800,000 to 5,000,000 g/mol, and it was obtained via in situ polymerization with a nanosized layered clay, more specifically, an organophylic phyllosilicate. The mixture is thus extruded, under suitable concentrations, with the aid of a spinning solvent. After the extrusion of the multi-filament bundle in the form of a gel, the multi-filaments are cooled in water, for instance, at 0° C., the spinning solvent is eliminated and the filaments are drawn in at least one stage, under high temperatures, until achieving those characteristic mechanical properties of a high performance yarn, namely, at least 18 cN/denier tensile strength and at most 0.07% per hour creep.

### BRIEF DESCRIPTION OF THE DRAWINGS

FIG. 1, comprising FIG. 1(a) and FIG. 1(b), is a schematic representation of the polyethylene molecules without nanofillers (a) and with dispersed nonfillers (b).

FIG. 2 is a TEM micrograph of the nanocomposite used in the yarn formulation.

FIG. 3 is a graph showing the correlation between yarn tensile strength and clay contents.

FIG. 4 is a graph showing the between yarn creep and clay content.

### DETAILED DESCRIPTION OF THE INVENTION

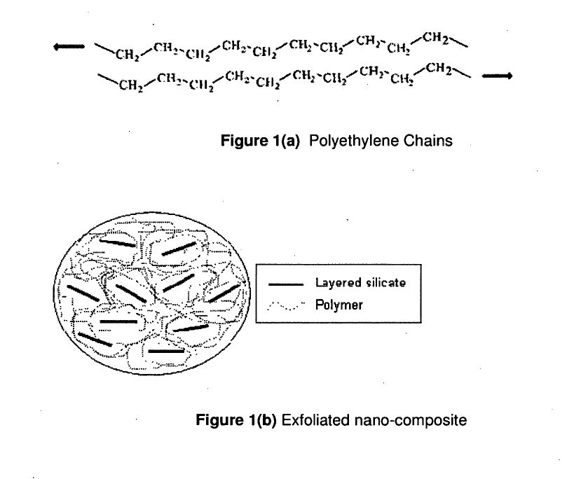

The creep reduction effect of the products obtained from the process of the present invention is depicted in FIG. 1. When the molecules are plainly aligned, as in FIG. 1a, the resulting interactions between the polymer chains, such as polyethylene, are weak Van der Waals forces, which allow their inter-slippage and their creep. When the polymer molecules are aligned and interspersed with nanofillers, such as the case in the model well known in the art and depicted in FIG. 1b, the inter-slippage of those molecules is impaired by the rigid and inorganic phyllosilicate layers and by the entanglement of the polymer molecules around said layers. As such, the phenomenon of chain creeping under stress is reduced.

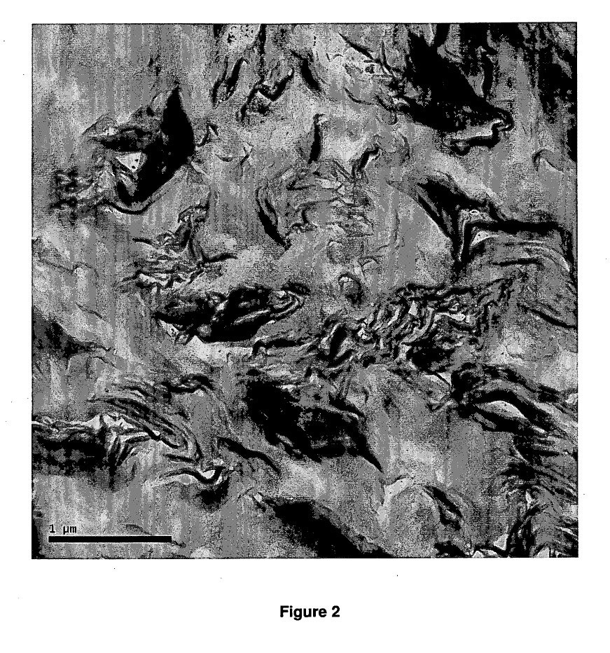

As it can be seen in FIG. 1b, the polymer is added in between the layers of said used nanosized clay. These two phases are chemically harmonious and dispersed in a nanometric scale. As such, besides the exfoliation of the clay in an efficient manner, the rigid clay layers impair the slippage of the polyethylene chains, in turn significantly reducing creep of the resulting yarn. The transmission electron micrograph (TEM), shown in FIG. 2, portrays the phyllosilicate layering within the polymer. It is observed that, at a nanometric magnitude, the phyllosilicate is homogeneously exfoliated in the polymer matrix, which enhances the improvement of the finished product's mechanical properties. The low creep paired to the high tensile strength of the yarn so produced makes it possible for it to be used in the mooring cables and lines market, besides being used in ballistic materials and fishing lines applications.

According to another aspect of the present invention, there is provided a process for the production of high tensile strength and low creep polymer yarns comprising the following steps:

a. preparing a mixture of: (i) a first ultra high molecular weight polyolefin polymer or copolymer, (ii) a second clay nanocomposite polyolefin polymer or copolymer, and (iii) a non-polar spinning solvent,

b. feeding the resulting suspension through an extruder at a temperature of at least 180° C., causing the formation of a gel,

c. spinning the gel so obtained in a spinneret with a length to diameter ratio (L/D) of at least 15,

d. cooling the yarn to a temperature below 2° C.,

e. subsequently removing the non polar spinning solvent, and

f. drawing the yarn so obtained so as to achieve a tensile strength value of at least 18 cN/Dtex and a creep value lower than 0.07% per hour, wherein the first ultra high molecular weight polyolefin polymer or copolymer has a weight-average molecular weight higher than 2,000,000 g/mol and a polydispersivity of at least 7, and the second clay nanocomposite polyolefin polymer or copolymer is obtained via in situ polymerization of an olefin and an exfoliated layered clay, the polyolefin so obtained having a weight-average molecular weight of at least 400,000 g/mol.

In another aspect of the present invention, high tensile strength and low creep polymer or copolymer yarns are manufactured, which comprise a first ultra high molecular weight ethylene polymer or copolymer associated to a second ethylene polymer or copolymer which has a clay type nanofiller and, optionally, another filler with biocide activity, which yarns have tensile strength of at least 15 cN/Dtex, creep lower than 0.07% per hour, elongation lower than 5% and elastic modulus of at least 55 GPa.

In another aspect of the present invention, the polymeric yarns so produced are intended for manufacturing mooring ropes and cables and hose reinforcements, submitted to constant high stresses for long periods of time.

### Raw Materials

### The Polymers

The polymer materials used in the present invention are polyolefin polymers or copolymers derivatives.

The first ultra high molecular weight polymer or copolymer is obtained from C₂₊ₙ monomers, wherein n varies from 0 to 2, which can comprise up to 4% of olefin comonomer, and has a weight-average molecular weight of at least 2,000,000 g/mol, preferably from 3,000,000 to 8,000,000 g/mol, polydispersivity of at least 7, and a multimodal or bimodal molecular weight distribution.

The second polymer or copolymer clay nanocomposite is obtained from C₂₊ₙ monomers, wherein n varies from 0 to 4, which has a weight-average molecular weight of at least 400,000 g/mol, preferably from 800,000 to 5,000,000 g/mol, comprising 0.5 to 50%, by weight, of nanometric filler.

When a mixture of the first and second polymers is used for the accomplishment of the process of the present invention, the polymer mixture formed in step (a) can contain, for instance, from 0.1 to 50 wt %, or more of the second polymer, wherein the preferable amount of polymer clay nanocomposite in the polymer mixture of the second polymer is from about 0.1 to 30 wt %.

When only the second polymer or copolymer clay-nanocomposite is used, it must have a polydispersivity of at least 7 and a weight-average molecular weight of at least 3,000,000 g/mol.

### The Solvent

The solvents used in the present invention are non-polar solvents usually employed in gel-spinning processes, such as paraffinic based oils and greases, decalin, tetralin, etc. According to the spinning solvent of choice, a second extraction solvent may be necessary, and in this case, di-ethyl ether, di-chloro-methane, di-chloro-ethane, n-hexane, n-heptane, being preferably the n-hexane.

In the extrusion step of the present invention, the spinning solvent concentration is at most 95 wt %, and preferably from 70 wt % to 92 wt %, relative to the total suspension weight.

### The Nanosized Fillers

The nanosized exfoliated clay layers present in the second clay nanocomposite polymer or copolymer have particle sizes smaller than 100 nm. Said clays are selected from organophylic phyllosilicates, such as: bentonites, montmorillonites, micas, hydromicas, vermiculites, muscovites, saponites, celadonites, or mixtures thereof. Nanosized clay contents can vary from 0.5 to 50 wt %, relative to polymer weight.

Spherical nanosized silver with a particle size around 15 nm can also be used as an additional nanofiller. The contents of spherical silver nanosized particles added to the polymer can be from 0.5 to 5 wt %, relative to polymer weight.

### Process Conditions

In the process of the present invention, the initial polymer and solvent mixing stage is carried out at room temperature, under strong agitation and circulation and, preferably, under N₂ inerting conditions.

The mixture extrusion is carried out in a single screw extruder, with an increasing temperature profile, starting at 230° C.

The yarn goes through a spinneret with length to diameter (L/D) ratio equal to 30, followed by cooling down to a temperature of 2° C.

The solvent is removed from the yarn via extraction with a second solvent, at room temperature, under N₂ inerting conditions and, in sequence the yarn is dried under N₂.

Subsequently, the yarn is drawn to at least 10 times its original length, in more than one step. The first drawing happens at 100° C. and the last drawing happens at 120° C. The yarn drawing speed is controlled.

### Properties of the Finished Yarn

The yarn obtained according to the present invention has tensile strength of at least 15 cN/Dtex, preferably from 18 to 35 cN/Dtex, creep lower than 0.07% per hour, preferably from 0.005 to 0.05% per hour, elongation lower than 5% and elastic modulus of at least 55 GPa.

### Methods Used to Determine the Properties of Yarns According to the Present Invention

Tensile strength, elastic modulus, elongation: The mechanical properties of the yarns were determined in a DL 500 Model EMIC apparatus, at a temperature of 23° C., using a 250 mm gap between clamps and a tensile speed of 250 mm/min, according to ISO 2062.

Creep: The creep was measured in a DL 500 Model EMIC apparatus, at a temperature of 23° C., during 13 hours and a load of 30% of the material breaking stress.

Transmission Electron Microscopy (TEM): The micrographs were obtained in a JEM 1220 Jeol Model Microscope.

The following examples were carried out according to the process described above. The yarns so obtained were characterized according to the methods listed above.

### COMPARATIVE EXAMPLE

An ultra high molecular weight polyethylene in 90% paraffinic base mineral oil slurry was prepared, with molecular weight around 3,000,000 g/mol, and multimodal molecular weight distribution, having polydispersivity of at least of 7. This formulation did not comprise any type of phyllosilicate or nanofiller. The polymer slurry in oil was directly fed to a single screw extruder with a length to diameter ratio (L/D) around 35, at a speed of 36 rpm. Inside the extruder, the gelling process initiates after a specific residence time and at high temperatures. The gel is fed to a spinneret by means of a gear pump, at a proper rate. The gel goes through the 0.3 mm diameter, 20 holes spinneret, at a temperature of 290° C., thus forming a continuous filament bundle. Said filaments are cooled in water at a temperature between −5° C. and 5° C., and in sequence, the mineral oil is extracted by means of a volatile solvent such as n-hexane. The dry, or partially dry, yarns are hot drawn in at least two steps, until a final draw ratio greater than 18:1. The yarn so obtained has the properties shown in Table 1. The high tensile strength of such a yarn type is known to the art, and the percent creep per hour was 0.112.

### EXAMPLES 1 TO 4 OF THE PRESENT INVENTION

### Example 1

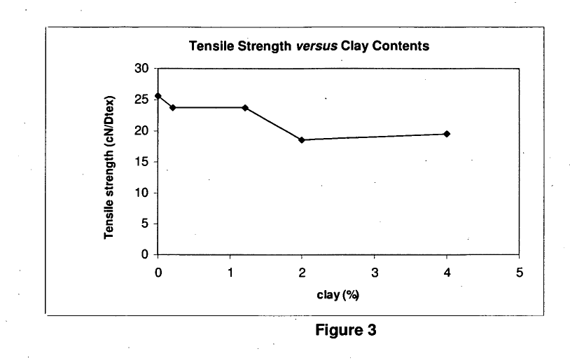

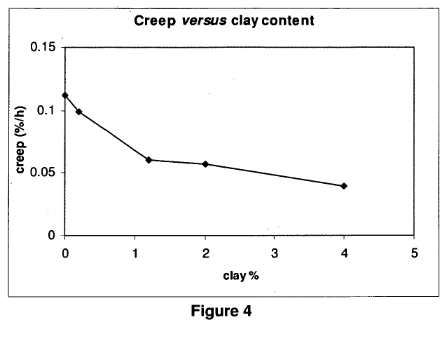

A mixture of an ultra high molecular weight polyethylene, which has the same characteristics as those described in the Comparative Example above, and a polyethylene nanocomposite containing 40 wt % of a nanosized layered clay was prepared, so that the clay weight ratio relative to the total final polymer weight is 0.2%. The mixture was extruded with the aid of a spinning solvent. Extrusion, spinning and drawing conditions were identical to those listed for the Comparative Example. The yarn so obtained presented the properties shown in Table 1. As depicted in FIGS. 3 and 4, a 7% tensile strength decrease and a 12% creep improvement were observed, which indicate that the clay does have a positive influence in the creep properties of the final yarn obtained, even at such low level contents.

### Example 2

The same slurry as in Example 1 was prepared, yet the ratio of clay weight relative to total final polymer weight was around 1.2%. Extrusion, spinning and drawing conditions were identical to those listed for the Comparative Example. The yarn so obtained presented the properties shown in Table 1. As depicted in FIGS. 3 and 4, the decrease in tensile strength was the same as for the previous clay contents of 0.2%. However, the creep improvement was 46% relative to that of the yarn with no filler.

### Example 3

The same slurry as in Examples 1 and 2 was prepared, however the ratio of clay weight relative to the total final polymer weight was around 2%. Extrusion, spinning and drawing conditions were identical to those listed for the Comparative Example. The yarn so obtained presented the properties shown in Table 1. As depicted in FIGS. 3 and 4, the increase in clay contents led to a 26% tensile strength drop and to creep values very close to those of a mixture which would contain 1.2 wt % of nanofiller.

### Example 4

The same slurry as in Examples 1, 2 and 3 was prepared, however the ratio of clay weight relative to the total final polymer weight was around 4%. Extrusion, spinning and drawing conditions were identical to those listed for the Comparative Example. The yarn so obtained presented the properties shown in Table 1. Tensile strength was around the same values observed in Example 3, but there was a major creep value decrease, of the order of 65%, or else to a figure of 0.040% per hour. The graph in FIG. 4 shows creep behavior as a function of filament clay contents.

TABLE 1
Tensile strength and creep values of the yarns obtained

| | | | Tensile strength | Creep |
|---|---|---|---|---|
| Example | Formulation | | (cN/Dtex) | (% per hour) |
| Comparative | no | clay | 25.7 | 0.112 |
| 1 | 0.2% | clay | 23.8 | 0.0099 |
| 2 | 1.2% | clay | 23.7 | 0.060 |
| 3 | 2% | clay | 18.6 | 0.057 |
| 4 | 4% | clay | 19.5 | 0.040 |

According to the results obtained, the process of the present invention is capable of providing high tensile strength and low creep yarns, particularly applicable to mooring cables and ropes, where the yarn is subjected to high stresses for long periods of time.

Notwithstanding a loss of up to, for instance, 25% yarn tensile strength, the yarns of the present invention are definitely advantageous in the manufacture of mooring cables and ropes, since they are capable of withstanding high stresses with very low creep, properties required for these types of applications.

It is observed that from 2% clay contents in the yarn formulation, tensile strength values begin to stabilize around 19 cN/Dtex, while creep values continue to diminish, down to figures around 0.040% per hour. This tendency is better observed in FIGS. 3 and 4.

1. Process for the production of high tensile strength and low creep polymer yarns, wherein it comprises the following steps:
a. preparing a mixture of: (i) a first ultra high molecular weight polyolefin polymer or copolymer, (ii) a second clay nanocomposite polyolefin polymer or copolymer, and (iii) a non-polar spinning solvent,
b. feeding the resulting suspension through an extruder at a temperature of at least 180° C., causing the formation of a gel,
c. spinning the gel so obtained in a spinneret with a length to diameter ratio (L/D) at least of 15,
d. cooling the yarn to a temperature below 2° C.,
e. subsequently removing the non-polar spinning solvent, and
f. drawing the yarn thus obtained so as to achieve a tensile strength value of at least 18 cN/Dtex and a creep value lower than 0.07% per hour, wherein the first ultra high molecular weight polyolefin polymer or copolymer has a weight-average molecular weight higher than 2,000,000 g/mol and a polydispersivity of at least 7, and the second clay nanocomposite polyolefin polymer or copolymer is obtained via in situ polymerization of an olefin and an exfoliated layered clay, the polyolefin so obtained having a weight-average molecular weight of at least 400,000 g/mol.

2. Process according to claim 1, wherein the mixture of step (a) comprises only said second clay nanocomposite polyolefin polymer or copolymer and a non-polar solvent, as long as the polydispersivity of said second clay nanocomposite polymer or copolymer be at least 7 and its weight-average molecular weight be higher than 3,000,000 g/mol.

3. Process according to claim 1, wherein said first ultra high molecular weight polymer or copolymer is obtained from C₂₊ₙ monomers, wherein n varies from 0 to 2.

4. Process according to claim 1, wherein said first ultra high molecular weight polymer or copolymer is a copolymer with up to 4 wt % of an olefin comonomer.

5. Process according to claim 1, wherein said first ultra high molecular weight polymer or copolymer is a polyethylene or a copolymer thereof.

6. Process according to claim 1, wherein said first ultra high molecular weight polymer or copolymer is a polypropylene or a copolymer thereof.

7. Process according to claim 1, wherein said first ultra high molecular weight polymer or copolymer has a multimodal molecular weight distribution.

8. Process according to claim 7, wherein said first ultra high molecular weight polymer or copolymer has a bimodal molecular weight distribution.

9. Process according to claim 1, wherein said first ultra high molecular weight polymer or copolymer preferably has a weight-average molecular weight between 3,000,000 and 8,000,000 g/mol.

10. Process according to claim 1, wherein the polymer matrix of said second clay nanocomposite polymer or copolymer is obtained from C₂₊ₙ monomers, wherein n varies from 0 to 4.

11. Process according to claim 1, wherein said second clay nanocomposite polymer or copolymer is obtained via in situ polymerization supported on the layer of a nanosized clay type compound.

12. Process according to claim 1, wherein the polymer matrix of said second clay nanocomposite polymer or copolymer is polyethylene or a copolymer thereof.

13. Process according to claim 1, wherein the polymer matrix of said second clay nanocomposite polymer or copolymer is polypropylene or a copolymer thereof.

14. Process according to claim 1, wherein said second clay nanocomposite polymer or copolymer preferably has a weight-average molecular weight between 800,000 and 5,000,000 g/mol.

15. Process according to claim 1, wherein, in the step (e), the removal of said non-polar spinning solvent is made via extraction with a second solvent or via volatilization thereof.

16. Process according to claim 1, wherein the tensile strength of said yarn preferably is from 18 to 35 cN/Dtex.

17. Process according to claim 1, wherein the creep of said yarn preferably is from 0.005 to 0.05% per hour.

18. Process according to claim 1, wherein, in the step (b), the suspension has at most 95 wt % of non-polar spinning solvent.

19. Process according to claim 18, wherein, in said step (b), the suspension preferably has from 70 to 92 wt % of non-polar spinning solvent.

20. Process according to claim 1, wherein said second clay nanocomposite polymer or copolymer has from 0.5 to 50 wt % of nanosized clay.

21. Process according to claim 1, wherein the polymer mixture of the step (a) has from 0.1 to 30 wt % clay nanocomposite polymer.

22. Process according to claim 1, wherein said in situ exfoliated layered clay present in the second nanocomposite polymer or copolymer can be chosen from the group comprising organophylic phyllosilicates, such as bentonites, montmorillonites, micas, hydromicas, vermiculites, muscovites, saponites, celadonites, or mixtures thereof, with particle sizes smaller than 100 nm.

23. Process according to claim 1, wherein the suspension of the step (b) may additionally contain another nanosized filler, selected among compounds that impart biocidal activities to the spun product so obtained.

24. Process according to claim 23, wherein said nanosized filler is selected among spherical nanosized silver particles of around 15 nm.

25. High tensile strength and low creep polymer or copolymer yarns, wherein they are obtained from the process defined in claim 1.

26. High tensile strength and low creep polymer or copolymer yarns, wherein they comprise a first ultra high molecular weight ethylene polymer or copolymer in association with a second ethylene polymer or copolymer which contains a clay type nanofiller, and optionally they have another nanofiller with a biocidal activity, said yarns having tensile strength of at least 15 cN/Dtex, creep lower than 0.07% per hour elongation lower than 5% and elastic modulus of at least 55 GPa.

27. Polymer yarns according to claim 25, wherein said yarn tensile strength preferably ranges from 18 to 35 cN/Dtex.

28. Polymer yarns according to claim 25, wherein said yarn creep preferably ranges from 0.005 to 0.05% per hour.

29. Polymer yarns according to claim 26, wherein said clay type nanofiller is selected among phyllosilicates such as, bentonites, montmorillonites, micas, hydromicas, vermiculites, muscovites, saponites, celadonites, or mixtures thereof.

30. Polymer yarns according to claim 26, wherein said nanofiller with biocidal activity is selected among spherical silver nanosized particles of around 15 nm.

31. Polymer yarns according to claim 30, wherein said nanofiller with biocidal activity is a nano-silver.

32. Polymer yarns according to claim 25, wherein they have high tensile strength, low creep and, optionally, biocide active compounds.

33. Use of the polymer yarns obtained according to the process defined in claim 1, wherein they are used to manufacture mooring cables and ropes as well as hose reinforcements, which are subject to constant high stresses for long periods of time.

34. Use of the polymer yarns obtained according to the process defined in any claim 1, wherein they are used to manufacture ballistic materials and fishing lines.

35. Use of the polymer yarns defined in claim 26, wherein they are used to manufacture mooring cables and ropes as well as hose reinforcements, which are subjected to constant high stresses for long periods of time.

36. Use of the polymer yarns defined in claim 26, wherein they are used to manufacture ballistic materials and fishing lines.
